(19) United States
(12) Patent Application Publication
(10) Pub. No.: US 2013/0094433 A1
(43) Pub. Date: Apr. 18, 2013

(54) RADIO RELAY STATION APPARATUS AND MOBILE TERMINAL APPARATUS

(71) Applicants: Satoshi Nagata, Tokyo (JP); Tetsushi Abe, Tokyo (JP)

(72) Inventors: Satoshi Nagata, Tokyo (JP); Tetsushi Abe, Tokyo (JP)

(73) Assignee: NTT DOCOMO, INC., Tokyo (JP)

(21) Appl. No.: 13/703,377

(22) PCT Filed: Jun. 15, 2011
(86) PCT No.: PCT/JP2011/063743

§ 371 Date: Jan. 7, 2013

(30) Foreign Application Priority Data
Jun. 21, 2010 (JP) 2010-140338

(51) Int. Cl. H04W 52/46

(52) U.S. Cl. CPC H04W 52/46
USPC 370/315

(57) ABSTRACT

A radio relay station apparatus and a mobile terminal apparatus that, even if a radio relay station apparatus is provided, can reduce the amount of interference from the radio relay station apparatus and increase the throughput, are provided. The radio relay station apparatus of the present invention decides the number of mobile terminal apparatuses under the subject cell and controls transmission power based on this number of mobile terminal apparatuses, or measures the received power of the signal from another radio relay station apparatus or a radio base station apparatus and controls transmission power based on this received power.

### TECHNICAL FIELD

The present invention relates to a radio relay station apparatus and a mobile terminal apparatus to utilize a relay transmission technique in an LTE-A (Long Term Evolution-Advanced) system.

### BACKGROUND ART

In 3GPP (3rd Generation Partnership Project), the standardization of LTE-Advanced (LTE-A) is in progress, as a fourth-generation mobile communication system to realize communication of further increased speed and increased volume from LTE (Long Term Evolution), which is an enhanced standard of the third-generation mobile communication system. In addition to realization of communication of increased speed and increased volume, for LTE-A, increase of the throughput of cell-edge users is an important object, and, as a means for this, a relay technique to relay radio transmission between a radio base station apparatus and mobile terminal apparatuses is under study. By using a relay technique, in places where it is difficult to secure a wired backhaul link, efficient expansion of coverage is anticipated.

Relay techniques include layer 1 relay, layer 2 relay, and layer 3 relay. Layer 1 relay is a relay technique called “booster” or “repeater,” and is an AF (Amplifier and Forward) type relay technique to amplify the power of a downlink received RF signal from a radio base station apparatus and transmit that downlink received RF signal to a mobile terminal apparatus. An uplink received RF signal from the mobile terminal apparatus is also subjected to power amplification and transmitted to the radio base station apparatus. Layer 2 relay is a DF (Decode and Forward) type relay technique to demodulate/decode a downlink received RF signal from a radio base station apparatus, and, after that, perform coding/modulation again, and transmit the result to a mobile terminal apparatus. Layer 3 relay is a relay technique to decode a downlink received RF signal from a radio base station apparatus and after that perform demodulation/decoding processes, and, in addition, after reconstruction of user data, perform the process for performing user data transmission by radio again (concealment, user data division/coupling processes, and so on), and, after coding/modulation, transmit the result to a mobile terminal apparatus.

Presently, in 3GPP, standardization is in progress with respect to the layer 3 relay technique, from the perspectives of improvement of reception performance by noise cancellation, discussion of the specifications of the standard and feasibility of implementation.

FIG. 1 is a diagram showing an overview of a radio relay technique by layer 3 relay. A radio relay station apparatus (RN) of layer 3 relay performs user data reconstruction, modulation/demodulation, and coding/decoding processes, and, in addition, has a feature of having a unique cell ID (PCI: Physical Cell ID) that is different from that of a radio base station apparatus (eNB). By this means, a mobile terminal apparatus (UE) identifies cell B provided by the radio relay station apparatus as a different cell from cell A provided by the radio base station apparatus. Also, physical layer control signals such as CQI (Channel Quality Indicator), HARQ (Hybrid Automatic Repeat reQuest) and so on end in the radio relay station apparatus, so that, seen from the mobile terminal apparatus, the radio relay station apparatus is identified as a radio base station apparatus. Consequently, a mobile terminal apparatus having LTE functions alone can be connected to the radio relay station apparatus.

Also, the backhaul link (Un) between the radio base station apparatus and the radio relay station apparatus and the access link (Uu) between the radio relay station apparatus and the mobile terminal apparatus may be operated at different frequencies or at the same frequency, and, in the latter case, when the transmitting/receiving processes are performed at the same time in the radio relay station apparatus, unless sufficient isolation can be secured in the transmitting/receiving circuits, a transmission signal goes to the receiver of the radio relay station apparatus and causes interference.

Consequently, as shown in FIG. 2, upon operation at the same frequency (f1), radio resources (eNB transmission and relay transmission) for the backhaul link and the access link are time-division multiplexed (TDM: Time Division Multiplexing), and it is necessary to control the radio relay station apparatus not to perform transmission and reception at the same time (non-patent literature 1). Consequently, for example, on the downlink, the radio relay station apparatus is unable to transmit a downlink signal to the mobile terminal apparatus while receiving a downlink signal from the radio base station apparatus.

### CITATION LIST

### Non-Patent Literature

Non-Patent Literature 1: 3GPP, TR36.814

### SUMMARY OF THE INVENTION

### Technical Problem

However, as shown in FIG. 3, when a plurality of radio relay station apparatuses (relay nodes: RNs) are provided, the amount of interference against mobile terminal apparatuses increases. For example, in FIG. 3, at the relay UE of RN #1 (the UE under RN #1), the transmission signal from RN #2 becomes interference, and, at the relay UE of RN #2 (the UE under RN #2), the transmission signal from RN #1 becomes interference. In this way, by providing RNs, compared to the case where a radio base station apparatus (macro eNB) alone is provided, the amount of interference to give to other cells by transmitted and received signals from the RNs increases.

The present invention has been made in view of the above problems, and it is therefore an object of the present invention to provide a radio relay station apparatus and a mobile terminal apparatus which, even if a radio relay station apparatus is provided, can reduce the amount of interference from the radio relay station apparatus and increases throughput.

### Solution to Problem

A radio relay station apparatus according to the present invention is a radio relay station apparatus to relay a signal that is received via a backhaul link to a mobile terminal apparatus via an access link, and this radio relay station apparatus has a feature of including: a decision section that decides the number of mobile terminal apparatuses under a subject cell; and a transmission power control section that controls transmission power based on the number of mobile terminal apparatuses.

A radio relay station apparatus according to the present invention is a radio relay station apparatus to relay a signal that is received via a backhaul link to a mobile terminal apparatus via an access link, and has a feature of including: a measurement section that measures the received power of a signal from another radio relay station apparatus or radio base station apparatus; and a transmission power control section that controls transmission power based on the received power.

A mobile terminal apparatus according to the present invention is a mobile terminal apparatus to receive a signal that is relayed at a radio relay station apparatus, via an access link, and includes: a measurement section that measures the received power of a signal from the radio relay station apparatus; a generation section that generates a control signal to command an increase or decrease of transmission power based on the received power; and a transmission section that transmits the control signal to the radio relay station apparatus.

### Technical Advantages of the Invention

According to the present invention, the number of mobile terminal apparatuses under the subject cell is decided and transmission power is controlled based on this number of mobile terminal apparatuses, or the received power of signals from other radio relay station apparatuses or radio base station apparatuses is measured and transmission power is controlled based on this received power, so that, even if a radio relay station apparatus is provided, it is still possible to reduce the amount of interference from the radio relay station apparatus and increase the throughput.

### BRIEF DESCRIPTION OF THE DRAWINGS

FIG. 1 is a diagram for explaining a relay transmission technique;

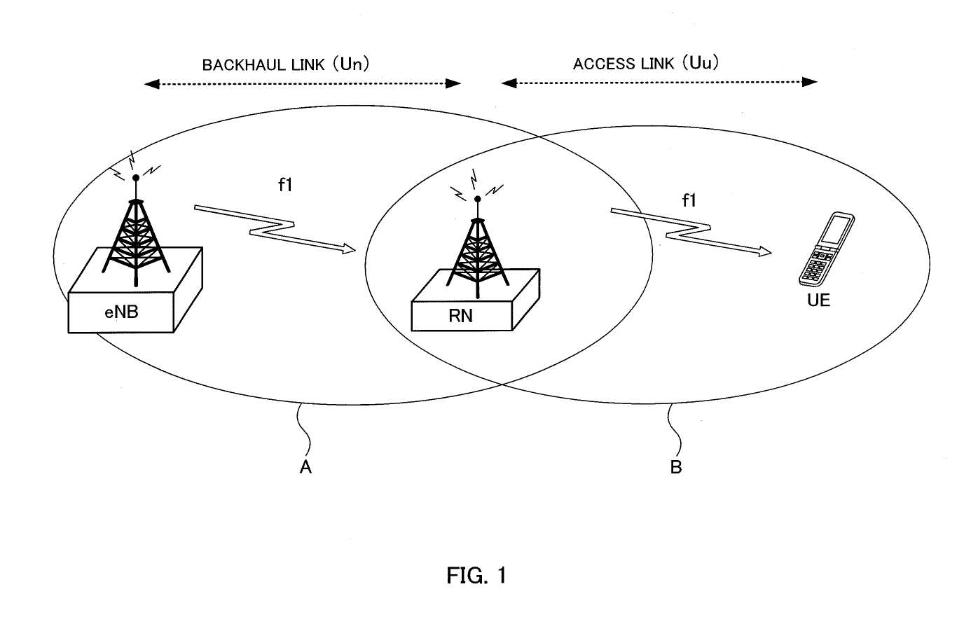

FIG. 2 is a diagram for explaining backhaul link and access link radio resources;

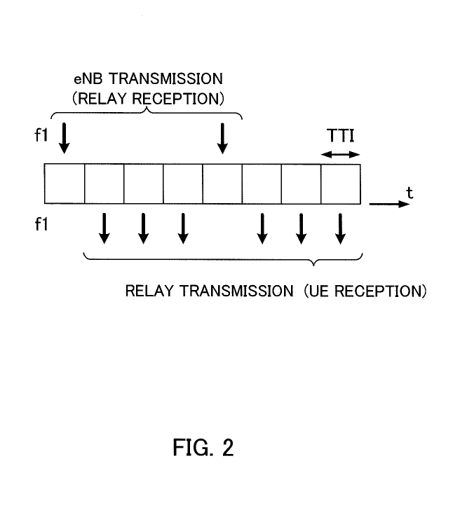

FIG. 3 is a diagram for explaining a radio relay method;

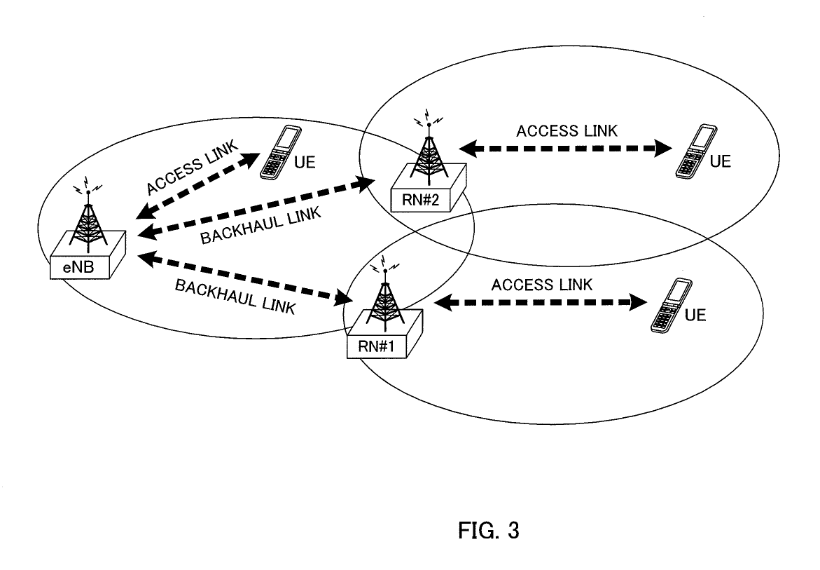

FIG. 4 is a diagram for explaining a radio relay station apparatus according to the present invention;

FIG. 5 is a diagram for explaining a radio relay station apparatus according to the present invention;

FIG. 6 is a diagram for explaining a radio relay station apparatus according to the present invention;

FIG. 7 is a diagram for explaining a radio relay station apparatus according to the present invention;

FIG. 8 is a diagram for explaining a configuration of a radio relay station apparatus according to embodiment 1 of the present invention;

FIG. 9 is a diagram for explaining a configuration of a mobile terminal apparatus according to embodiment 1 to embodiment 3 of the present invention;

FIG. 10 is a diagram for explaining a configuration of a radio relay station apparatus according to embodiment 2 and embodiment 3 of the present invention; and

FIG. 11 is a diagram for explaining a configuration of a mobile terminal apparatus according to embodiment 4 of the present invention.

### DESCRIPTION OF EMBODIMENTS

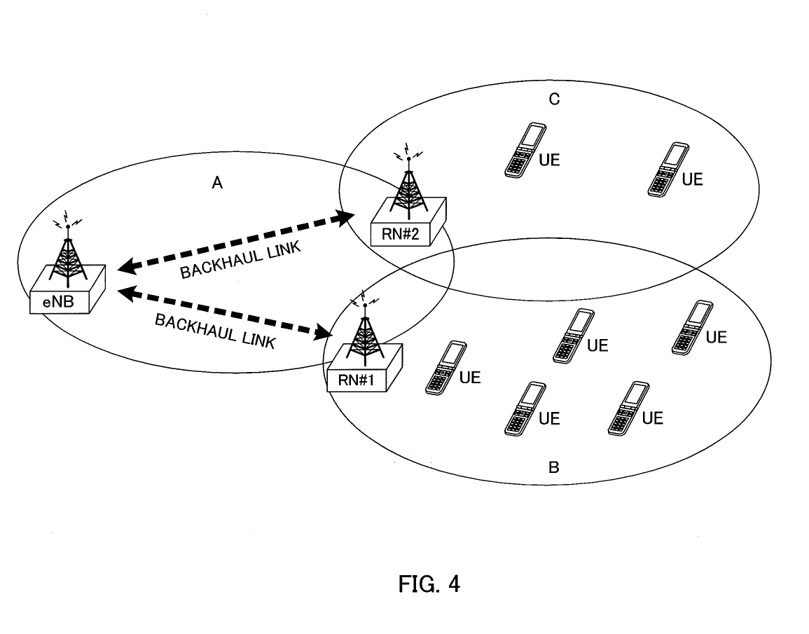

Now, embodiments of the present invention will be described below in detail with reference to the accompanying drawings. FIG. 4 to FIG. 7 are diagrams for explaining radio relay station apparatuses according to the present invention. In FIG. 4 to FIG. 7, cell A is the cell provided by the radio base station apparatus (eNB), cell B is the cell provided by radio relay station apparatus (RN) #1, and cell C is the cell provided by radio relay station apparatus (RN) #2.

According to the present invention, in order to reduce the interference against other cells by transmitted and received signals from radio relay station apparatuses (RNs) that relay signals that are received via a backhaul link, to mobile terminal apparatuses, via an access link, the following four modes are provided.

### (Mode 1)

With the present mode, the number of mobile terminal apparatuses under the subject cell is decided, and transmission power is controlled based on this number of mobile terminal apparatuses (FIG. 4). If the number of mobile terminal apparatuses under the subject cell is small, transmission power is reduced and interference against mobile terminal apparatuses under other cells is reduced, and, on the other hand, if the number of mobile terminal apparatuses under the subject cell is large, transmission power is increased, and communication quality for mobile terminal apparatuses under the subject cell is secured. That is to say, by the transmission power control according to the present mode, the number of mobile terminal apparatuses under the subject cell is measured, and, when the number of mobile terminal apparatuses is equal to or smaller than a predetermined number, transmission power is lowered or transmission is stopped, and, when the number of mobile terminal apparatuses exceeds a predetermined number, transmission power is increased. In the case shown in FIG. 4, the number of mobile terminal apparatuses under RN #1 is greater than the number of mobile terminal apparatuses under RN #2. For example, the number of mobile terminal apparatuses under RN #1 is smaller than a predetermined number, and the number of mobile terminal apparatuses under RN #2 is greater than a predetermined number. In this case, transmission power is lowered at RN #2, or transmission power is increased at RN #1. Also, it is equally possible to lower transmission power at RN #2 and increase transmission power at RN #1. Then, a predetermined number of mobile terminal apparatuses is set as a threshold value in advance. Note that the number of mobile terminal apparatuses can be measured by, for example, counting the number of demodulated uplink transmission data.

### (Mode 2)

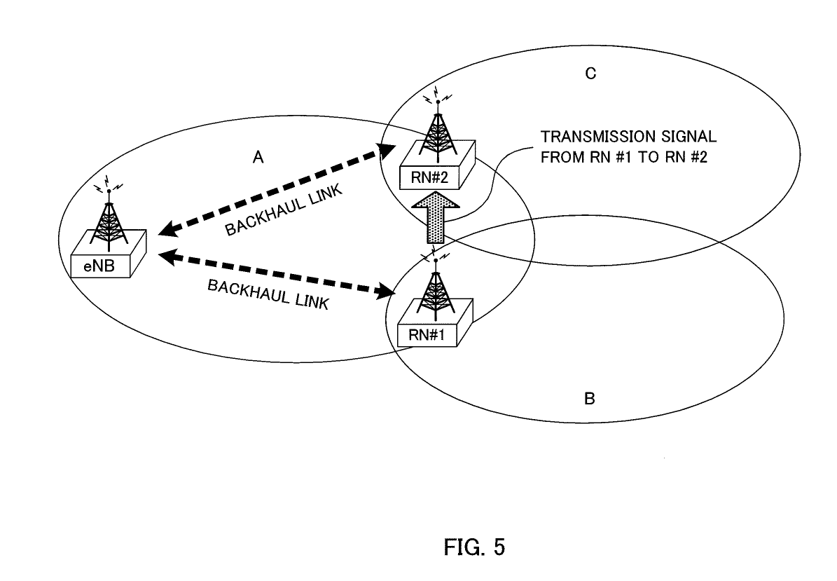

With the present mode, the received power of the signal from another RN is measured, and transmission power is controlled based on this received power. If the received power of the signal from another RN (RN #1, for RN #2 of FIG. 5) is large (the transmission power of another RN is large), transmission power is reduced, and interference against mobile terminal apparatuses under another cell (RN #1) is reduced, and, on the other hand, if the received power of the signal from another RN (RN #1, for RN #2 of FIG. 5) is small (the transmission power of another RN is small), transmission power is increased, and communication quality for mobile terminal apparatuses under the subject cell is secured. That is to say, by the transmission power control according to the present mode, the received power of the signal from another RN is measured, and, if the received power exceeds a predetermined value, transmission power is lowered or transmission is stopped, and, if the received power is equal to or lower than a predetermined value, transmission power is increased. In the case shown in FIG. 5, when the power of the signal from RN #1 to RN #2 is large, transmission power is lowered at RN #2, and, when the power of the signal from RN #1 to RN #2 is small, transmission power is increased at RN #2. Then, a predetermined value of received power is set in advance as a threshold value.

### (Mode 3)

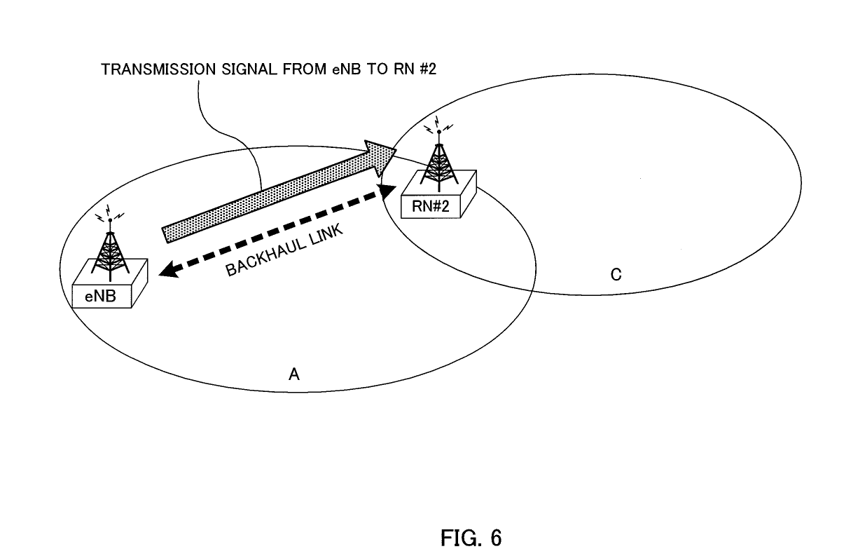

With the present mode, the received power of a signal from a radio base station apparatus (eNB) is measured, and transmission power is controlled based on this received power (FIG. 6). If the received power of the signal of the eNB is large (the transmission power of the eNB is large), transmission power is reduced, and interference against mobile terminal apparatuses under the eNB is reduced, and, on the other hand, if the received power of the signal of the eNB is small (the transmission power of the eNB is small), transmission power is increased, and communication quality for mobile terminal apparatuses under the subject cell is secured. That is to say, by the transmission power control according to the present mode, the received power of a signal from an eNB is measured, and, when the received power exceeds a predetermined value, transmission power is lowered or transmission is stopped, and, when the received power is equal to or lower than a predetermined value, transmission power is increased. In the case shown in FIG. 6, when the power of the signal from the eNB to RN #2 is large, transmission power is lowered at RN #2, and, when the power of the signal from the eNB to RN #2 is small, transmission power is increased at RN #2. Then, a predetermined value of received power is set in advance as a threshold value.

### (Mode 4)

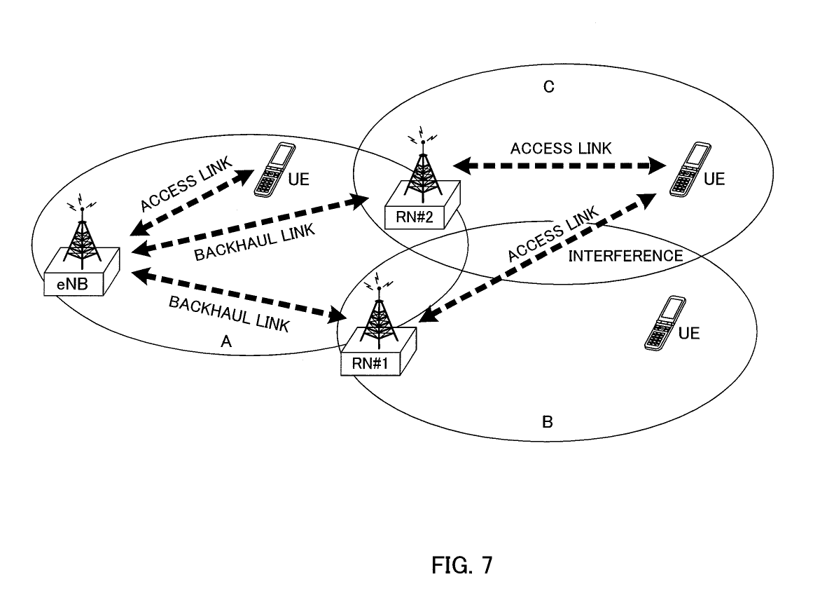

With the present mode, a mobile terminal apparatus that receives a signal relayed at an RN via an access link, measures the received power of the signal from the RN, generates a control signal to command an increase or decrease of transmission power based on this received power, and transmits the control signal to the RN (FIG. 7). The RN control transmission power based on the control signal transmitted from the mobile terminal apparatus.

If the received power of the signal from the RN that communicates with the subject apparatus is large (the transmission power of the RN is large), a control signal to the effect of reducing transmission power is transmitted to the RN, and interference against mobile terminal apparatuses under other RNs is reduced. On the other hand, if the received power is small (the transmission power of the RN is small), a control signal to the effect of increasing transmission power is transmitted to the RN, and communication quality for mobile terminal apparatuses under the subject cell is secured. That is to say, by the transmission power control in this mode, a mobile terminal apparatus measures the received power of the signal from the RN that communicates with the subject apparatus, and, when the received power exceeds a predetermined value, generates a control signal to the effect of reducing transmission power and transmits this control signal to the RN, and, when the received power is equal to or lower than a predetermined value, generates a control signal to the effect of increasing transmission power and transmits this control signal to the RN. In the case shown in FIG. 7, when the power of the signal from RN #2 is large, the mobile terminal apparatus under RN #2 generates a control signal to the effect of reducing transmission power at RN #2, and transmits this control signal to RN #2. Also, when the power of the signal from RN #2 is small, the mobile terminal apparatus under RN #2 generates a control signal to the effect of increasing transmission power at RN #2, and transmits this control signal to RN #2. Then, a predetermined value of received power is set in advance as a threshold value.

Also, apart from the RN that communicates with the subject apparatus, if the received power of signals from the RN that does not communicate with the subject apparatus and the eNB is large (the transmission power of the RN and eNB is large), a control signal to the effect of reducing transmission power is transmitted to the RN that communicates with the subject apparatus, and interference against mobile terminal apparatuses under other RNs is reduced. On the other hand, if the received power is small (the transmission power of the RN and eNB is small), a control signal to the effect of increasing transmission power is transmitted to the RN, and communication quality for mobile terminal apparatuses under the subject cell is secured. That is to say, by the transmission power control in this mode, a mobile terminal apparatus measures the received power of signals from the RN that communicates with the subject apparatus, the RN that does not communicate with the subject apparatus and the eNB that does not communicate with the subject apparatus, and, when the received power exceeds a predetermined value, generates a control signal to the effect of reducing transmission power and transmits this control signal to the RN, and, when the received power is equal to or lower than a predetermined value, generates a control signal to the effect of increasing transmission power and transmits this control signal to the RN. In the case shown in FIG. 7, when the power of signals from RN #1, RN #2 and the eNB is large, the mobile terminal apparatus under RN #2 generates a control signal to the effect of reducing transmission power at RN #2 and transmits this control signal to RN #2. Also, when the power of signals from RN #1, RN #2 and the eNB is small, the mobile terminal apparatus under RN #2 generates a control signal to the effect of increasing transmission power at RN #2 and transmits this control signal to RN #2. Then, a predetermined value of received power is set in advance as a threshold value.

Note that, according to the present mode, control signals from a mobile terminal apparatus to an RN are reported using, for example, an uplink control channel.

### Embodiment 1

A case will be described here with the present embodiment where the number of mobile terminal apparatuses under the subject cell is decided and transmission power is controlled based on this number of mobile terminal apparatuses.

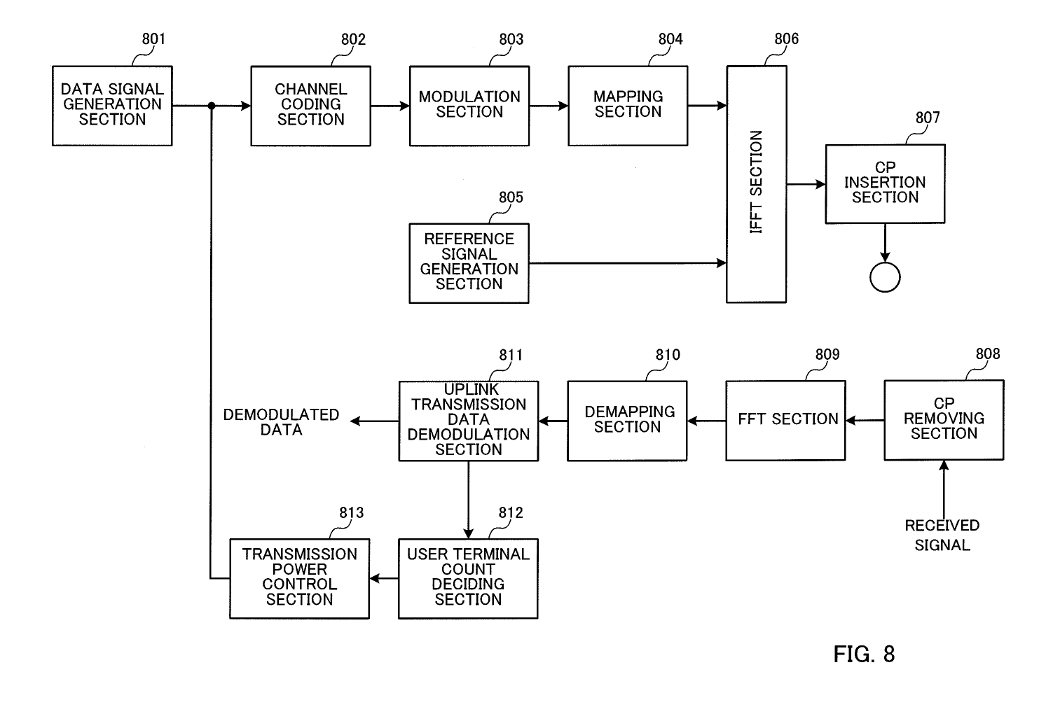

FIG. 8 is a block diagram showing a schematic configuration of a radio relay station apparatus according to embodiment 1 of the present invention. The transmitting side of the radio relay station apparatus shown in FIG. 8 includes a data signal generation section 801, a channel coding section 802, a modulation section 803, a mapping section 804, a reference signal generation section 805, an IFFT (Inverse Fast Fourier Transform) section 806, and a CP (Cyclic Prefix) insertion section 807. Also, the receiving side of the radio relay station apparatus includes a CP removing section 808, an FFT (Fast Fourier Transform) section 809, a demapping section 810, an uplink transmission data demodulation section 811, a user terminal count deciding section 812, and a transmission power control section 813.

The data signal generation section 801 generates a downlink data signal to transmit to a relay node (RN), and a downlink data signal to transmit to a relay UE (a mobile terminal apparatus under the relay node). The data signal generation section 801 outputs these downlink data signals to the channel coding section 802.

The channel coding section 802 performs channel coding of the downlink data signals. The channel coding section 802 outputs the data signals after the channel coding, to the modulation section 803. The modulation section 803 modulates the data after the channel coding. The modulation section 803 outputs the data signals after the data modulation, to the mapping section 804. The mapping section 804 maps frequency domain signals to subcarriers based on resource allocation information. The mapping section 804 outputs the mapped data signals to the IFFT section 806. The reference signal generation section 805 generates a reference signal and outputs that reference signal to the IFFT section 806.

The IFFT section 806 converts the data signals and the reference signal into time domain signals through the IFFT. The IFFT section 806 outputs the signals after the IFFT to the CP insertion section 807. The CP insertion section 807 inserts CPs in the signals after the IFFT. The signals in which the CPs have been inserted are transmitted to mobile terminal apparatuses (UEs) on the downlink of the access link.

The CP removing section 808 removes the CPs from the received signals. The CP removing section 808 outputs the signals after the removal of the CPs to the FFT section 809. The FFT section 809 performs the FFT process of signals after the removal of the CPs. The FFT section 809 outputs the signals after the FFT to the demapping section 810. The demapping section 810 demaps the signals after the FFT and outputs the demapped signals to the uplink transmission data demodulation section 811. The uplink transmission data demodulation section 811 performs demodulation using uplink transmission data signals and provides demodulated data.

The user terminal count deciding section 812 measures the number of mobile terminal apparatuses, and, comparing that number and a predetermined number (threshold value), decides whether the number of user terminals is larger or smaller than the predetermined number. Note that the number of mobile terminal apparatuses can be decided by counting the number of demodulated uplink transmission data. The user terminal count deciding section 812 outputs the decided result to the transmission power control section 813.

The transmission power control section 813 controls transmission power based on the number of mobile terminal apparatuses. In this case, when the number of mobile terminal apparatuses is equal to or smaller than a predetermined number, transmission power is lowered or transmission is stopped, and, when the number of mobile terminal apparatuses exceeds a predetermined number, transmission power is increased.

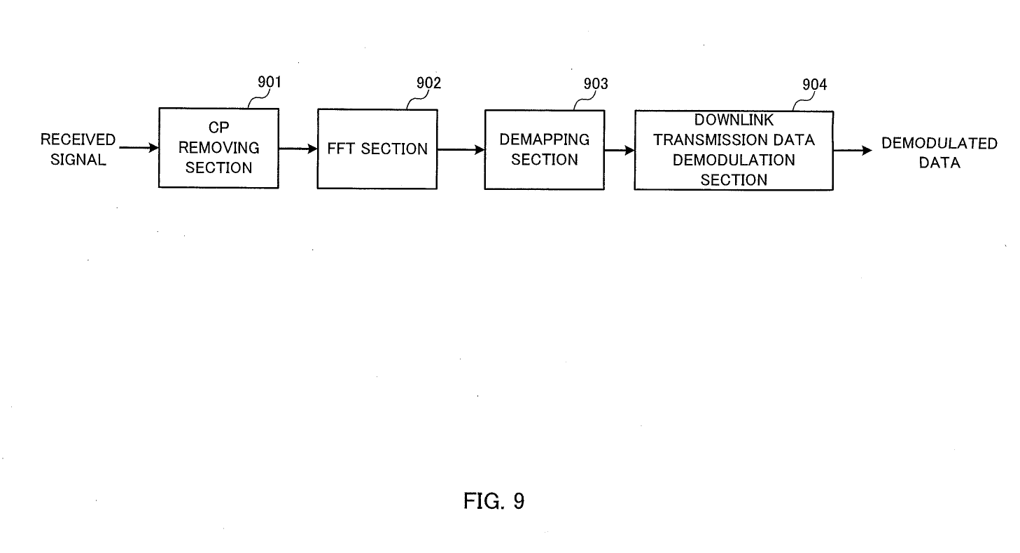

FIG. 9 is a block diagram showing a schematic configuration of a mobile terminal apparatus according to embodiment 1 of the present invention. The receiving side of the radio relay station apparatus shown in FIG. 9 includes a CP removing section 901, an FFT section 902, a demapping section 903, and a downlink transmission data demodulation section 904.

The CP removing section 901 removes the CPs from received signals. The CP removing section 901 outputs the signals after the removal of the CPs, to the FFT section 902. The FFT section 902 performs an FFT process of the signals after the removal of the CPs. The FFT section 902 outputs the signals after the FFT to the demapping section 903. The demapping section 903 demaps the signals after the FFT, and outputs the demapped signals to the downlink transmission data demodulation section 904. The downlink transmission data demodulation section 904 performs demodulation using downlink transmission data signals, and provides demodulated data.

The radio relay method by a radio relay station apparatus having the above configuration will be described. To be more specific, the radio relay method will be described using the configuration shown in FIG. 4. At RN #2, the user terminal count deciding section 812 decides the number of mobile terminal apparatuses under RN #2, and, comparing that number and a predetermined number of user terminals (four, in this case), decides whether the number of user terminals is larger or smaller than the predetermined number. There are two mobile terminal apparatuses under RN #2, so that the number of user terminals is smaller than a predetermined number. Next, given that the number of mobile terminal apparatuses is equal to or smaller than a predetermined number, the transmission power control section 813 lowers transmission power. On the other hand, at RN #1, the user terminal count deciding section 812 measures the number of mobile terminal apparatuses under RN #1, and, comparing that number and a predetermined number of user terminals (four, in this case), decides whether the number of user terminals is larger or smaller than the predetermined number. There are five mobile terminal apparatus under RN #1, so that the number of user terminals is greater than a predetermined number. Next, given that the number of mobile terminal apparatuses exceeds a predetermined number, the transmission power control section 813 increases transmission power.

In this way, with the radio relay method according to the present embodiment, the number of mobile terminal apparatuses under the subject cell is decided, and transmission power is controlled based on this number of mobile terminal apparatuses, so that, even if a radio relay station apparatus is provided, it is still possible to lower the amount of interference from the radio relay station apparatus and increase the throughput.

### Embodiment 2

A case will be described here with the present embodiment where the received power of a signal from another radio relay station apparatus is measured and transmission power is controlled based on this received power. The configuration of mobile terminal apparatus according to the present embodiment is the same as the configuration shown in FIG. 9.

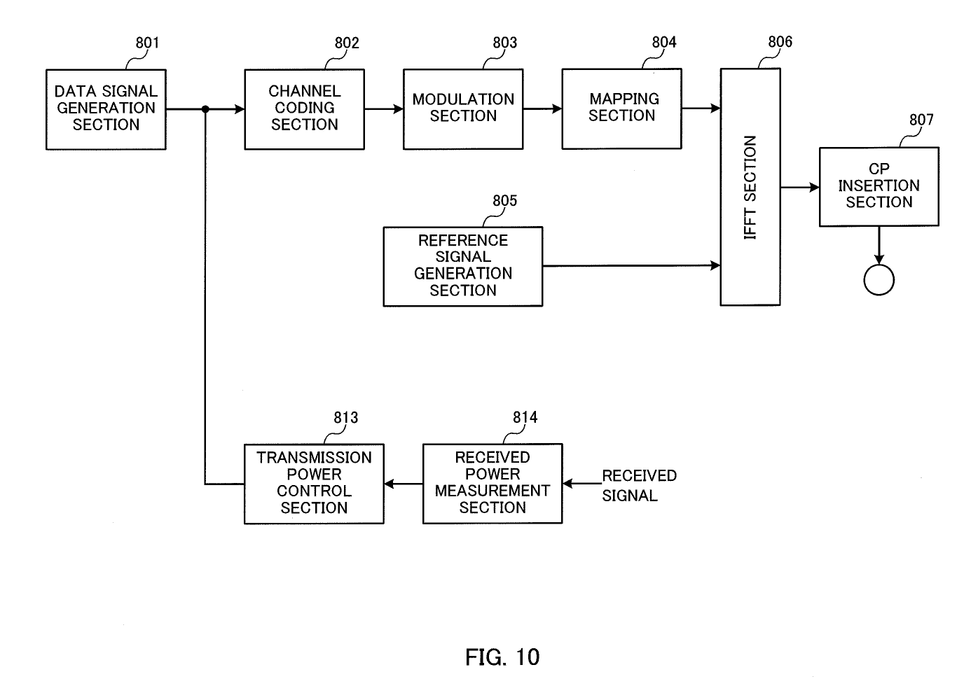

FIG. 10 is a block diagram showing a schematic configuration of a radio relay station apparatus according to embodiment 2 of the present invention. Parts in FIG. 10 that are the same as in FIG. 8 will be assigned the same codes as in FIG. 8 and their detailed to descriptions will be omitted. The radio relay station apparatus shown in FIG. 10 has a received power measurement section 814.

The received power measurement section 814 measures the received power of the signal from another RN (the signal from RN #1 to RN #2 in FIG. 5), and, comparing that received power and a predetermined number (threshold value), decides whether the received power is higher or lower than the predetermined value. The received power measurement section 814 outputs the decided result to the transmission power control section 813.

The transmission power control section 813 controls transmission power based on the received power of the signal from another RN. In this case, when the received power exceeds a predetermined value, transmission power is lowered or transmission is stopped, and, when the received power is equal to or lower than a predetermined value, transmission power is increased.

The radio relay method by a radio relay station apparatus having the above configuration will be described. To be more specific, the radio relay method will be described using the configuration shown in FIG. 5. At RN #2, the received power measurement section 814 measures the received power of the signal from RN #1, and, comparing that received power and a predetermined value, decides whether the received power is higher or lower than the predetermined value. When the received power of the signal from RN #1 is higher than a predetermined value, the transmission power control section 813 lowers transmission power or stops transmission, and, when the received power is equal to or lower than a predetermined value, increases transmission power.

In this way, by the radio relay method according to the present embodiment, the received power of the signal from another radio relay station apparatus is measured, and transmission power is controlled based on this received power, so that, even if a radio relay station apparatus is provided, it is still possible to reduce the amount of interference from radio relay station apparatus and increase the throughput.

### Embodiment 3

A case will be described here with the present embodiment where the received power of the signal from a radio base station apparatus is measured and transmission power is controlled based on this received power. The configuration of a mobile terminal apparatus according to the present embodiment is the same as the configuration shown in FIG. 9, and the configuration of a radio relay station apparatus is the same as the configuration shown in FIG. 10.

The received power measurement section 814 measures the received power of the signal from an eNB (the signal from the eNB to RN #2 in FIG. 6), and, comparing that received power and a predetermined number (threshold value), decides whether the received power is higher or lower than the predetermined value. The received power measurement section 814 outputs the decided result to the transmission power control section 813.

The transmission power control section 813 controls transmission power based on the received power of the signal from the eNB. In this case, when the received power exceeds a predetermined value, transmission power is lowered or transmission is stopped, and, when the received power is equal to or lower than a predetermined value, transmission power is increased.

The radio relay method by a radio relay station apparatus having the above configuration will be described. To be more specific, the radio relay method will be described using the configuration shown in FIG. 6. At RN #2, the received power measurement section 814 measures the received power of the signal from an eNB, and, comparing that received power and a predetermined value, decides whether the received power is higher or lower than the predetermined value. The transmission power control section 813 lowers transmission power or stops transmission when the received power of the signal from the eNB is higher than a predetermined value, and increases transmission power when the received power is equal to or lower than a predetermined value.

In this way, with the radio relay method according to the present embodiment, the received power of the signal from a radio base station apparatus is measured and transmission power is controlled based on this received power, so that, even if a radio base station apparatus is provided, it is still possible to reduce the amount of interference from the radio base station apparatus and increase the throughput.

### Embodiment 4

A case will be described here with the present embodiment where the received power of signals from RNs is measured, a control signal to command an increase or decrease of transmission power is generated based on this received power, this control signal is transmitted to the RNs, and transmission power is controlled at the RNs based on the control signal. The configuration of the radio relay station apparatus according to the present embodiment is the same as the configuration shown in FIG. 10, except that the received power measurement section 814 is not necessary.

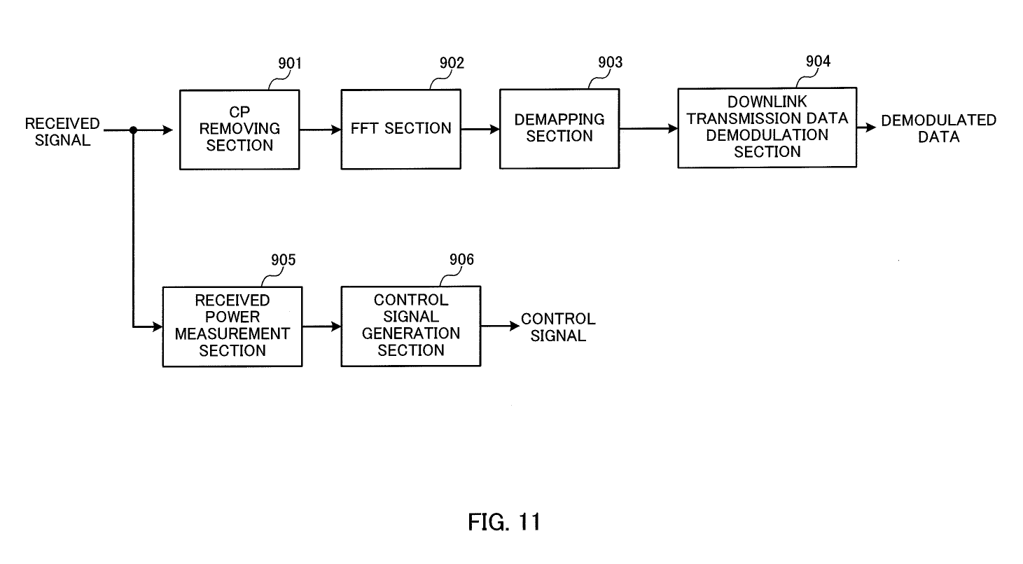

FIG. 11 is a block diagram showing a schematic configuration of a mobile terminal apparatus according to embodiment 4 of the present invention. Parts in FIG. 11 that are the same as in FIG. 9 will be assigned the same codes as in FIG. 9 and their detailed descriptions will be omitted. The mobile terminal apparatus shown in FIG. 11 includes a received power measurement section 905 and a control signal generation section 906.

The received power measurement section 905 measures the received power of signals from RNs (the signal from RN #1 and the signal from RN #2 in FIG. 7), and, comparing that received power and a predetermined number (threshold value), decides whether the received power is higher or lower than a predetermined value. The received power measurement section 905 measures the received power of the signal from the RN that communicates with the subject apparatus, and, comparing that received power and a predetermined number (threshold value), decides whether the received power is higher or lower than the predetermined value. Also, the received power measurement section 905 measures the received power of the signals from the RN that communicates with the subject apparatus, the RN that does not communicate with the subject apparatus and the eNB, and, comparing the received power and a predetermined number (threshold value), decides whether or not the received power is higher or lower than a predetermined value. The received power measurement section 905 outputs the decided result to the control signal generation section 906.

The control signal generation section 906 generates a control signal based on the decided result of the received power measurement section 905. When, for example, a decided result to indicate that the received power exceeds a predetermined value is given, the control signal generation section 906 generates a control signal to the effect of reducing transmission power (or stopping transmission), and, when a decided result to indicate that the received power is equal to or lower than a predetermined value is given, generates a control signal to the effect of increasing transmission power.

The control signal generated in the control signal generation section 906 is subjected to a predetermined transmission process, and, after that, transmitted from the mobile terminal apparatus to the RNs. After that, the RNs control transmission power according to the control signal.

The radio relay method by a radio relay station apparatus having the above configuration will be described. To be more specific, the radio relay method will be described using the configuration shown in FIG. 7. At a UE under RN #2, the received power measurement section 905 measures the received power of the signal from RN #2, and, comparing that received power and a predetermined value, decides whether the received power is higher or lower than the predetermined value. The transmission power control section 906 generates a control signal to the effect of lowering transmission power when the received power of the signal from RN #2 is higher than a predetermined value, and generates a control signal to the effect of lowering transmission power (stopping transmission) when the received power is equal to or lower than a predetermined value. After that, the UE transmits an uplink signal including the control signal to RN #2. At RN #2, the transmission power control section 813 lowers transmission power (stops transmission) or increases transmission power in accordance with the control signal from the UE.

Also, at the UE under RN #2, the received power measurement section 905 measures the received power of the signal from RN #1, the received power of the signal from RN #2 and the received power of the signal from the eNB, and, comparing the total of received power and a predetermined value, decides whether the total of received power is higher or lower than the predetermined value. When the total of the received power of the signal from RN #1, the received power of the signal from RN #2 and the received power of the signal from the eNB is higher than a predetermined value, the transmission power control section 906 generates a control signal to the effect of lowering transmission power, and, when the total of received power is equal to or lower than a predetermined value, generates a control signal to the effect of lowering transmission power (stopping transmission). After that, the UE transmits the uplink signal including the control signal to RN #2. At RN #2, the transmission power control section 813 lowers transmission power or increases transmission power (stops transmission) in accordance with the control signal from the UE.

In this way, with the radio relay method according to the present embodiment, a mobile terminal apparatus measures the received power of a signal from a radio relay station apparatus, generates a control signal based on this received power, and transmits this control signal to the radio relay station apparatus, and the radio relay station apparatus controls transmission power in accordance with the control signal, so that, even if a radio base station apparatus is provided, it is still possible to reduce the amount of interference from the radio base station apparatus and increase the throughput.

As has been described above in detail, the present specification covers the following inventions (A) and (B).

### Inventions A:

A radio relay station apparatus according to invention A1 is a radio relay station apparatus to relay a signal that is received via a backhaul link to a mobile terminal apparatus via an access link, and has a feature of including: a measurement section that measures the received power of a signal from another radio relay station apparatus or radio base station apparatus; and a transmission power control section that controls transmission power based on the received power.

In the radio relay station apparatus of invention A1, the transmission power control section lowers transmission power or stops transmission when the received power exceeds a predetermined value, and increases transmission power when the received power is equal to or lower than a predetermined value.

A radio relay method according to invention A2 includes the steps of: receiving a signal in a radio relay station apparatus via a backhaul link; relaying and transmitting the signal received via the backhaul link, to a mobile terminal apparatus, via an access link; at the radio relay station apparatus, measuring the received power of a signal from another radio relay station apparatus or radio base station apparatus; and controlling transmission power for relay and transmission based on the received power.

A communication system according to invention A3 includes a radio base station apparatus, a radio relay station apparatus that relays a signal that is transmitted from the radio base station apparatus, and a mobile terminal apparatus that receives the signal relayed at the radio relay station apparatus, and the radio relay station apparatus includes: a measurement section that measures the received power of a signal from another radio relay station apparatus or radio base station apparatus; and a transmission power control section that controls transmission power based on the received power.

### Inventions B:

A mobile terminal apparatus according to invention B1 is a mobile terminal apparatus to receive a signal that is relayed at a radio relay station apparatus, via an access link, and includes: a measurement section that measures the received power of a signal from the radio relay station apparatus; a generation section that generates a control signal to command an increase or decrease of transmission power based on the received power; and a transmission section that transmits the control signal to the radio relay station apparatus.

In the mobile terminal apparatus of invention B1, the generation section generates a control signal to the effect of reducing transmission power when the received power of the signal from the radio relay station apparatus that communicates with the subject apparatus exceeds a predetermined values, and generates a control signal to the effect of increasing transmission power when the received power of the signal from the radio relay station apparatus that communicates with the subject apparatus is equal to or lower than a predetermined value.

In the mobile terminal apparatus of invention B1, the generation section generates a control signal to the effect of reducing transmission power when the received power of a signal from at least one radio relay station apparatus and radio base station apparatus exceeds a predetermined value, and generates a control signal to the effect of increasing transmission power when the received power of a signal from at least one radio relay station apparatus and radio base station apparatus is equal to or lower than a predetermined value.

A communication control method according to invention B2 includes: receiving a signal relayed at a radio relay station apparatus in a mobile terminal apparatus via an access link; measuring the received power of the signal received in the mobile terminal apparatus from the radio relay station apparatus; generating a control signal to command an increase or decrease of transmission power based on the measured received power; and transmitting the generated control signal from the mobile terminal apparatus to the to radio relay station apparatus.

A communication system according to invention B3 includes a radio relay station apparatus that relays a signal transmitted from a radio base station apparatus, and a mobile terminal apparatus that receives the signal relayed at the radio relay station apparatus, and the mobile terminal apparatus includes a measurement section that measures the received power of the signal from the radio relay station apparatus; a generation section that generates a control signal to command an increase or decrease of transmission power based on the received power; and a transmission section that transmits the control signal to the radio relay station apparatus, and the radio relay station apparatus includes: a receiving section that receives the signal transmitted from the radio base station apparatus via a backhaul link and receives the control signal transmitted from the mobile terminal apparatus via an access link; a transmission section that relays and transmits the signal received via the backhaul link, to the mobile terminal apparatus via the access link; and a transmission power control section that controls transmission power for relay based on the command included in the control signal received via the access link.

The embodiments disclosed herein are only examples in all respects, and these embodiments are by no means limiting. The scope of the present invention is defined not only by the descriptions of the above embodiments and also is set by the claims, and covers all the modifications and alterations within the meaning and range equivalent to the claims.

### INDUSTRIAL APPLICABILITY

The present invention is suitable for use for a radio relay station apparatus and a radio relay method in the LTE-A system.

The disclosure of Japanese Patent Application No. 2010-140338, filed on Jun. 21, 2010, including the specification, claims, and abstract, is incorporated herein by reference in its entirety.

1. A radio relay station apparatus to relay a signal that is received via a backhaul link to a mobile terminal apparatus via an access link, the radio relay station apparatus comprising:
a decision section that decides the number of mobile terminal apparatuses under a subject cell; and
a transmission power control section that controls transmission power based on the number of mobile terminal apparatuses.

2. The radio relay station apparatus according to claim 1, wherein the transmission power control section lowers transmission power or stops transmission when the number of mobile terminal apparatuses is equal to or smaller than a predetermined number, and increases the transmission power when the number of mobile terminal apparatuses exceeds the predetermined number.

3. A radio relay method comprising the steps of:
receiving a signal in a radio relay station apparatus via a backhaul link;
relaying and transmitting the signal received via the backhaul link, from the radio relay station apparatus to a mobile terminal apparatus, via an access link;
deciding the number of mobile terminal apparatuses under a subject cell; and
controlling transmission power for relay and transmission based on the number of mobile terminal apparatuses.

4. A communication system comprising a radio base station apparatus, a radio relay station apparatus that relays a signal that is transmitted from the radio base station apparatus, and a mobile terminal apparatus that receives the signal relayed at the radio relay station apparatus, wherein the radio relay station apparatus comprises:
a decision section that decides the number of mobile terminal apparatuses under a subject cell; and
a transmission power control section that controls transmission power based on the number of mobile terminal apparatuses.
